(19) United States
(12) Patent Application Publication
(10) Pub. No.: US 2024/0424857 A1
(43) Pub. Date: Dec. 26, 2024

(54) COMBINED HEAT EXCHANGER AND HEAT EXCHANGE SYSTEM

(71) Applicant: DENSO CORPORATION, Kariya-city (JP)

(72) Inventors: Yoshio HAYASHI, Kariya-city (JP); Yoshiki KATO, Kariya-city (JP); Yukihisa IJUIN, Kariya-city (JP); Hiroaki KAWANO, Kariya-city (JP); Yasuhiro YOKOO, Kariya-city (JP); Junki HIRAYAMA, Kariya-city (JP); Naito MUTO, Kariya-city (JP); Kohei NOGUCHI, Kariya-city (JP)

(21) Appl. No.: 18/825,937

(22) Filed: Sep. 5, 2024

Related U.S. Application Data
(63) Continuation of application No. PCT/JP2023/007070, filed on Feb. 27, 2023.

(30) Foreign Application Priority Data
Mar. 11, 2022 (JP) 2022-038210

(51) Int. Cl. B60H 1/00; B60H 1/14; B60H 1/32

(52) U.S. Cl. CPC B60H 1/00278; B60H 1/00342; B60H 1/143; B60H 1/32284

(57) ABSTRACT

A combined heat exchanger exchanges heat between a refrigerant circulating through a vapor compression type refrigeration cycle, a first heat medium flowing through a first heat medium circuit including a first heat generating element, and a second heat medium flowing through a second heat medium circuit including a second heat generating element. The combined heat exchanger includes a refrigerant flow channel portion through which the refrigerant flows, a first heat medium flow channel portion through which the first heat medium flows, and a second heat medium flow channel portion through which the second heat medium flows. The refrigerant flow channel portion, the first heat medium flow channel portion, and the second heat medium flow channel portion are arranged to transfer heat of the refrigerant to both the first heat medium and the second heat medium.

### CROSS REFERENCE TO RELATED APPLICATIONS

The present application is a continuation application of International Patent Application No. PCT/JP2023/007070 filed on Feb. 27, 2023, which designated the U.S. and claims the benefit of priority from Japanese Patent Application No. 2022-038210 filed on Mar. 11, 2022.

### TECHNICAL FIELD

The present disclosure relates to a combined heat exchanger and a heat exchange system.

### BACKGROUND ART

Conventionally, a vehicle cooling system involves connecting a cooling circuit for a driving electrical device system to a vapor compression type refrigeration cycle via a heat exchanger. In this system, a cooling medium in the cooling circuit is cooled by a refrigerant in the refrigeration cycle.

### SUMMARY

According to at least one embodiment of the preset disclosure, a combined heat exchanger is configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element. The combined heat exchanger includes a refrigerant flow channel portion configured to allow the refrigerant to flow through the refrigerant flow channel portion, a first heat medium flow channel portion configured to allow the first heat medium to flow through the first heat medium flow channel portion, and a second heat medium flow channel portion configured to allow the second heat medium to flow through the second heat medium flow channel portion. The refrigerant flow channel portion, the first heat medium flow channel portion, and the second heat medium flow channel portion are arranged to transfer heat of the refrigerant to both the first heat medium and the second heat medium.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic configuration diagram of a heat exchange system according to an embodiment.

FIG. 2 is a schematic front view of a combined heat exchanger according to the embodiment.

FIG. 3 is an explanatory diagram for explaining flowing manners of a refrigerant, a first heat medium, and a second heat medium in the combined heat exchanger.

FIG. 4 is an explanatory diagram illustrating battery cooling by the refrigerant.

FIG. 5 is an explanatory diagram illustrating battery heating with heat of the first heat medium.

FIG. 6 is an explanatory diagram illustrating battery heating without using heat of the first heat medium.

### DETAILED DESCRIPTION

The present inventors have considered exchanging heat between a refrigerant in a refrigeration cycle with a first heat medium and a second heat medium flowing through different heat medium circuits. Such a configuration can be realized by adding a heat exchanger that exchanges heat between the refrigerant and the first heat medium and a heat exchanger that exchanges heat between the refrigerant and the second heat medium to the refrigeration cycle, but this would complicate a cycle configuration of the refrigeration cycle. The complication of the cycle configuration may lead to increased costs and heat loss.

The present disclosure can provide a combined heat exchanger and a heat exchange system capable of supplying heat of a refrigerant to a first heat medium and a second heat medium while reducing complication of a cycle configuration.

According to an aspect of the preset disclosure, a combined heat exchanger is configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element. The combined heat exchanger includes a refrigerant flow channel portion configured to allow the refrigerant to flow through the refrigerant flow channel portion, a first heat medium flow channel portion configured to allow the first heat medium to flow through the first heat medium flow channel portion, and a second heat medium flow channel portion configured to allow the second heat medium to flow through the second heat medium flow channel portion. The refrigerant flow channel portion, the first heat medium flow channel portion, and the second heat medium flow channel portion are arranged to transfer heat of the refrigerant to both the first heat medium and the second heat medium.

According to this, heat can be exchanged between three types of fluids, namely, the refrigerant, the first heat medium, and the second heat medium, in the single heat exchanger. Therefore, the heat of the refrigerant can be supplied to the first heat medium and the second heat medium while reducing the complication of the cycle configuration of the refrigeration cycle.

According to another aspect of the present disclosure, a heat exchange system is configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element. The heat exchange incudes a combined heat exchanger and a flow rate adjustment unit. The combined heat exchanger includes a refrigerant flow channel portion configured to allow the refrigerant to flow through the refrigerant flow channel portion, a first heat medium flow channel portion configured to allow the first heat medium to flow through the first heat medium flow channel portion, and a second heat medium flow channel portion configured to allow the second heat medium to flow through the second heat medium flow channel portion. The flow rate adjustment unit is configured to adjust a flow rate of the refrigerant flowing through the refrigerant flow channel portion, a flow rate of the first heat medium flowing through the first heat medium flow channel portion, and a flow rate of the second heat medium flowing through the second heat medium flow channel portion. The refrigerant flow channel portion, the first heat medium flow channel portion, and the second heat medium flow channel portion are arranged to transfer heat of the refrigerant to both the first heat medium and the second heat medium.

According to this, in the single heat exchanger, heat can be mutually exchanged between three types of fluids, namely, the refrigerant, the first heat medium, and the second heat medium, while adjusting the flow rates of the three types of fluids. Therefore, the heat of the refrigerant can be supplied to the first heat medium and the second heat medium while reducing the complication of the cycle configuration of the refrigeration cycle.

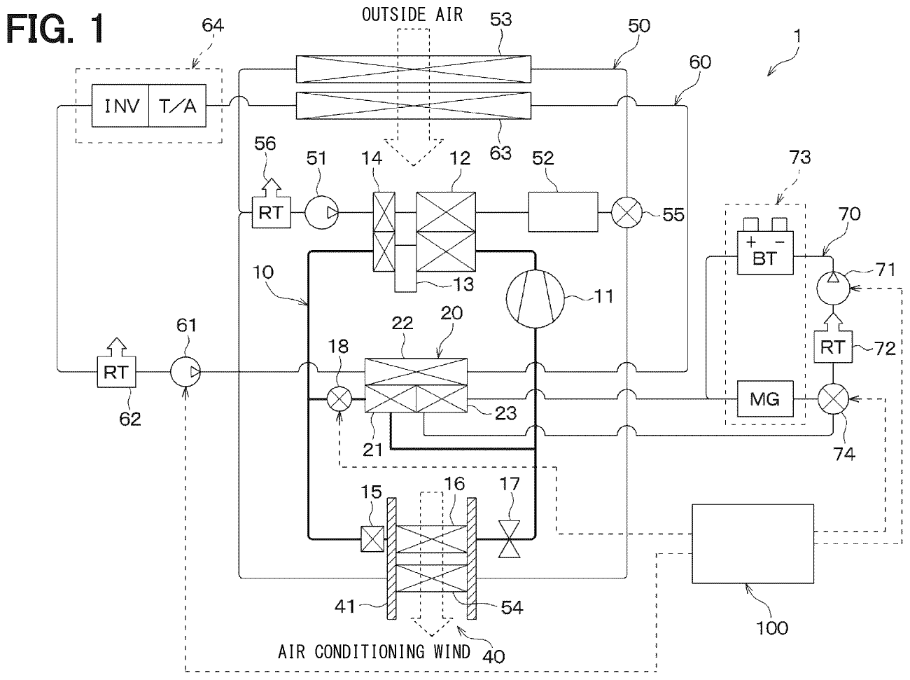

An embodiment of the present disclosure will be described with reference to FIGS. 1 to 6. In the present embodiment, an example in which a combined heat exchanger 20 according to the present disclosure is applied to a heat exchange system 1 for a vehicle will be described. The heat exchange system 1 for a vehicle is mounted in, for example, an electric vehicle that obtains a driving force for running the vehicle from a traveling electric motor. The electric vehicle is capable of charging a large-capacity battery BT mounted in the vehicle with electric power supplied from an external power source while the vehicle is stopped. The battery BT is a rechargeable secondary battery. The battery BT includes, for example, a lithium ion battery that has high energy density, is lightweight, and is compact.

The heat exchange system 1 includes a vapor compression type refrigeration cycle 10, a high-temperature side circuit 50, a first heat medium circuit 60 including a first heat generating element 64, a second heat medium circuit 70 including a second heat generating element 73, and a control unit 100. The heat exchange system 1 exchanges heat among a refrigerant flowing through the refrigeration cycle 10, a high-temperature side heat medium flowing through the high-temperature side circuit 50, a first heat medium flowing through the first heat medium circuit 60, and a second heat medium flowing through the second heat medium circuit 70.

The refrigeration cycle 10 has a compressor 11, a condenser 12, a liquid receiving unit 13, a subcooling unit 14, a first depressurization valve 15, an air conditioning evaporator 16, an evaporation pressure regulation valve 17, a second depressurization valve 18, and the combined heat exchanger 20.

A refrigerant used in the refrigeration cycle 10 is one with a low global warming coefficient, such as HFO-1234yf. The refrigerant includes refrigerator oil for lubricating the compressor 11. The refrigerator oil used is, for example, one that is compatible with a liquid-phase refrigerant such as PAG oil. A portion of the refrigerator oil circulates within a cycle of the refrigeration cycle 10 together with the refrigerant.

The compressor 11 is a device that compresses and discharges the refrigerant. The compressor 11 includes an electric compressor that is driven by electric power supplied from the battery BT. An operation of the compressor 11 is controlled by a control signal output from the control unit 100.

The condenser 12 is connected to a refrigerant discharge side of the compressor 11. The condenser 12 is a heat release device that exchanges heat between the high-temperature high-pressure refrigerant (hereinafter also referred to as high-pressure refrigerant) discharged from the compressor 11 and the high-temperature side heat medium flowing through the high-temperature side circuit 50, and releases heat of the high-pressure refrigerant to the high-temperature side heat medium. When passing through the condenser 12, the high-pressure refrigerant dissipates heat to the high-temperature side heat medium and is condensed.

The high-temperature side heat medium is a fluid that flows through the high-temperature side circuit 50. The high-temperature side heat medium is a liquid-phase fluid that does not change a phase when flowing through the high-temperature side circuit 50. The high-temperature side heat medium used is, for example, a liquid including ethylene glycol or an antifreeze liquid.

Here, the high-temperature side circuit 50 is a circuit for dissipating heat of the high-temperature side heat medium to an outside and for heating an inside of the vehicle compartment by using the high-temperature side heat medium. The high-temperature side circuit 50 is provided with a high-temperature side pump 51, an electric heater 52, a high-temperature side radiator 53, a heater core 54, a high-temperature side switching valve 55, and a high-temperature side reserve tank 56.

The high-temperature side pump 51 sucks in the high-temperature side heat medium and pumps the high-temperature side heat medium out toward the condenser 12, thereby circulating the high-temperature side heat medium within the high-temperature side circuit 50. The high-temperature side pump 51 is an electric pump that is driven by electric power supplied from the battery BT. The high-temperature side pump 51 also functions as adjusting means that adjusts a flow rate of the high-temperature side heat medium flowing through the high-temperature side circuit 50.

The electric heater 52 heats the high-temperature side heat medium. The electric heater 52 is an auxiliary heat source that heats the high-temperature side heat medium in a situation where the high-temperature side heat medium cannot be sufficiently heated by the condenser 12, for example. An energized state of the electric heater 52 is controlled by a control signal output from the control unit 100.

The high-temperature side radiator 53 exchanges heat between the high-temperature side heat medium heated by the condenser 12 and outside air outside the vehicle compartment, thereby dissipating heat of the high-temperature side heat medium. The high-temperature side radiator 53 is disposed, for example, on a front side in a traveling direction of the vehicle, and traveling wind flows thereinto when the vehicle is traveling.

The heater core 54 is disposed in parallel with the high-temperature side radiator 53 in the high-temperature side circuit 50. The heater core 54 is disposed inside a casing 41 of an air conditioning unit 40. The heater core 54 exchanges heat between the high-temperature side heat medium heated by the condenser 12 and air being blown into the vehicle compartment, thereby generating air conditioning wind at a desired temperature.

The high-temperature side switching valve 55 is disposed at a branching portion where a flow channel of the high-temperature side heat medium branches into the high-temperature side radiator 53 and the heater core 54. The high-temperature side switching valve 55 functions as a flow channel switching unit that switches the flow channel of the high-temperature side heat medium. The high-temperature side circuit 50 can switch the flow channel by a high-temperature side switching valve 55 between a flow channel in which the high-temperature side heat medium heated by the condenser 12 flows to the heater core 54 and a flow channel in which the high-temperature side heat medium heated by the condenser 12 flows to the high-temperature side radiator 53. The high-temperature side switching valve 55 includes an electromagnetic valve, and an operation is controlled by a control signal output from the control unit 100. The high-temperature side circuit 50 may be provided with a flow rate regulation valve instead of the high-temperature side switching valve 55. In this case, the flow rate of the high-temperature side heat medium flowing to the heater core 54 and the flow rate of the high-temperature side heat medium flowing to the high-temperature side radiator 53 can be appropriately adjusted by the flow rate regulation valve.

The high-temperature side reserve tank 56 is a tank for storing an excess high-temperature side heat medium. The high-temperature side reserve tank 56 is disposed on an inlet side of the high-temperature side heat medium in the high-temperature side pump 51.

The liquid receiving unit 13 is connected to a refrigerant outlet side of the condenser 12. The liquid receiving unit 13 stores an excess refrigerant in the refrigeration cycle 10. The liquid receiving unit 13 separates the refrigerant that has flowed out from the condenser 12 into gas and liquid phases, and causes the separated liquid-phase refrigerant to flow out downstream. The liquid receiving unit 13 may include either a receiver tank having an inlet and outlet for the refrigerant provided at a top, or a modulator tank having an inlet and outlet for the refrigerant provided at a bottom.

The subcooling unit 14 is connected to a refrigerant outlet side of the liquid receiving unit 13. The subcooling unit 14 exchanges heat between the liquid-phase refrigerant that has flowed out from the liquid receiving unit 13 and the high-temperature side heat medium before the high-temperature side heat medium flows into the condenser 12, thereby subcooling the liquid-phase refrigerant. In the present embodiment, the condenser 12 and the subcooling unit 14 form a “heat release device” that dissipates heat of the refrigerant discharged from the compressor 11.

The flow channel of the refrigerant branches into two at a refrigerant outlet side of the subcooling unit 14. The first depressurization valve 15 is connected to one of the flow channels on the refrigerant outlet side of the subcooling unit 14, and the second depressurization valve 18 is connected to the other flow channel.

The first depressurization valve 15 is a first depressurization portion that depressurizes the refrigerant that has passed through the subcooling unit 14. The first depressurization valve 15 is an electric variable aperture whose operation is controlled by a control signal output from the control unit 100, and has a valve body and an electric actuator. The first depressurization valve 15 is configured as a variable aperture with a full closing function that can substantially stop the flow of the refrigerant.

An air conditioning evaporator 16 is connected to a refrigerant outlet side of the first depressurization valve 15. The air conditioning evaporator 16 is disposed inside the casing 41 of the air conditioning unit 40 together with a heater core 54. The air conditioning evaporator 16 evaporates the refrigerant depressurized in the first depressurization valve 15 by exchanging heat between the refrigerant and the air being blown into the vehicle compartment. In the air conditioning evaporator 16, the refrigerant absorbs heat from the air being blown into the vehicle compartment and evaporates, thereby cooling the air. The air that has passed through the air conditioning evaporator 16 passes through the heater core 54 and is then supplied to the vehicle compartment as air conditioning wind.

The evaporation pressure regulation valve 17 is connected to a refrigerant outlet side of the air conditioning evaporator 16. The evaporation pressure regulation valve 17 is a pressure adjusting unit that maintains an evaporation pressure of the refrigerant in the air conditioning evaporator 16 at or above a predetermined reference pressure. The evaporation pressure regulation valve 17 is configured to adjust the evaporation pressure of the refrigerant in the air conditioning evaporator 16 such that a temperature of the air conditioning evaporator 16 becomes a temperature (for example, 1° C.) at which frost on the air conditioning evaporator 16 is reduced.

The second depressurization valve 18 is a second depressurization portion that depressurizes the refrigerant that has passed through the subcooling unit 14. The second depressurization valve 18 is connected downstream of the subcooling unit 14 such that the second depressurization valve is arranged in parallel with the first depressurization valve 15. The second depressurization valve 18 is an electric variable aperture whose operation is controlled by a control signal output from the control unit 100, and has a valve body and an electric actuator. The second depressurization valve 18 is configured as a variable aperture with a full closing function that can substantially stop the flow of the refrigerant.

The combined heat exchanger 20 is connected to a refrigerant outlet side of the second depressurization valve 18. The combined heat exchanger 20 is a chiller that evaporates the refrigerant depressurized in the second depressurization valve 18 by exchanging heat between the refrigerant and at least one of the first heat medium and the second heat medium.

The combined heat exchanger 20 includes a refrigerant flow channel portion 21 through which the refrigerant flows, a first heat medium flow channel portion 22 through which the first heat medium flows, and a second heat medium flow channel portion 23 through which a second heat medium flows. The refrigerant flow channel portion 21, the first heat medium flow channel portion 22, and the second heat medium flow channel portion 23 are disposed such that the heat of the refrigerant is transferred to both the first heat medium and the second heat medium. The refrigerant flow channel portion 21 is an evaporation portion that evaporates the refrigerant depressurized in the second depressurization valve 18. The refrigerant flow channel portion 21 transfers cold energy of the refrigerant to both the first heat medium and the second heat medium.

The first heat medium flow channel portion 22 is disposed adjacent to the refrigerant flow channel portion 21 to directly transfer the heat of the refrigerant to the first heat medium. The second heat medium flow channel portion 23 is disposed adjacent to the first heat medium flow channel portion 22 to indirectly transfer the heat of the refrigerant to the second heat medium via the first heat medium. The first heat medium flow channel portion 22 and the second heat medium flow channel portion 23 are disposed adjacent to each other to transfer heat of the first heat generating element 64 to the second heat medium via the first heat medium. The combined heat exchanger 20 will be described in detail later.

The first heat medium is a fluid that flows through the first heat medium circuit 60. The first heat medium is a liquid-phase fluid that does not change a phase when flowing through the first heat medium circuit 60. The first heat medium used is, for example, the same liquid as the high-temperature side heat medium or an antifreeze liquid.

The first heat medium circuit 60 includes in-vehicle devices such as an inverter INV and a transaxle T/A as the first heat generating element 64. The first heat medium circuit 60 is a circuit for adjusting a temperature of the in-vehicle devices by using the first heat medium, and for absorbing heat from the outside by using the first heat medium. The first heat medium circuit 60 is provided with a first circulation pump 61, a first reserve tank 62, a low-temperature side radiator 63, and the first heat generating element 64.

The first circulation pump 61 sucks in the first heat medium and pumps the first heat medium out toward the combined heat exchanger 20, thereby circulating the first heat medium within the first heat medium circuit 60. The first circulation pump 61 is an electric pump that is driven by electric power supplied from the battery BT. The first circulation pump 61 also functions as adjusting means that adjusts a flow rate of the first heat medium flowing through the first heat medium circuit 60.

The first reserve tank 62 is a tank for storing an excess first heat medium. The first reserve tank 62 is disposed between the first circulation pump 61 and the first heat generating element 64.

The low-temperature side radiator 63 is connected to an outlet side of the first heat medium in the combined heat exchanger 20. The low-temperature side radiator 63 exchanges heat between the first heat medium that has passed through the combined heat exchanger 20 and the outside air outside the vehicle compartment, thereby absorbing heat from the outside air. The low-temperature side radiator 63 is disposed, for example, together with the high-temperature side radiator 53, on the front side in the traveling direction of the vehicle. The high-temperature side radiator 53 and low-temperature side radiator 63 are arranged in series in this order in an outside air flowing direction. The high-temperature side radiator 53 and the low-temperature side radiator 63 are connected to each other via a common heat transfer fin (not shown) to be capable of transferring heat therebetween.

The first heat generating element 64 is a heat generating device such as the inverter INV and the transaxle T/A. The first heat generating element 64 is maintained at an appropriate temperature by dissipating heat to the first heat medium. In other words, the first heat medium circuit 60 absorbs heat from the first heat generating element 64 via the first heat medium. The in-vehicle device forming the first heat generating element 64 may be different from that described above.

The second heat medium is a fluid that flows through the second heat medium circuit 70. The second heat medium is a liquid-phase fluid that does not change a phase when flowing through the second heat medium circuit 70. The second heat medium used is, for example, a liquid (for example, oil) having a higher electrical insulation property than the first heat medium. Depending on the type of the battery BT, there is a concern that leakage of electricity to the second heat medium may occur. However, since the second heat medium is a liquid having a high electrical insulation property, leakage of electricity via the second heat medium is reduced.

The second heat medium circuit 70 is configured as a circuit independent of the first heat medium circuit 60. The second heat medium circuit 70 includes multiple heat generating bodies such as the battery BT and a motor generator MG as the second heat generating element 73. The second heat medium circuit 70 is a circuit for adjusting temperatures of the battery BT and the motor generator MG, which are heat generating bodies, by using the second heat medium. The second heat medium circuit 70 is provided with a second circulation pump 71, a second reserve tank 72, the second heat generating element 73, and a flow channel switching valve 74.

The second circulation pump 71 sucks in the second heat medium and pumps the second heat medium out toward the battery BT, thereby circulating the first heat medium within the second heat medium circuit 70. The second circulation pump 71 is an electric pump that is driven by electric power supplied from the battery BT. The second circulation pump 71 also functions as adjusting means that adjusts a flow rate of the second heat medium flowing through the second heat medium circuit 70.

The second reserve tank 72 is a tank for storing an excess second heat medium. The second reserve tank 72 is disposed between the second circulation pump 71 and the flow channel switching valve 74.

The second heat generating element 73 is heat generating devices such as the battery BT and the motor generator MG. The second heat generating element 73 is maintained at an appropriate temperature by dissipating heat to the second heat medium and absorbing heat from the second heat medium. The motor generator MG is arranged in parallel with the second heat medium flow channel portion 23 in the second heat medium circuit 70. The in-vehicle device forming the second heat generating element 73 may be different from that described above.

The flow channel switching valve 74 is a three-way valve that switches a flow channel of the second heat medium. The flow channel switching valve 74 switches the second heat medium pumped out from the second circulation pump 71 between a flow channel through which the second heat medium flows in an order of the battery BT→the second heat medium flow channel portion 23 of the combined heat exchanger 20 and a flow channel through which the second heat medium flows in an order of the battery BT→the motor generator MG. The operation of the flow channel switching valve 74 is controlled by a control signal output from the control unit 100. The second heat medium circuit 70 is provided with a flow channel switching valve 74, thereby being configured to transfer heat of the motor generator MG to the battery BT via the second heat medium. The second heat medium circuit 70 may be provided with a flow rate regulation valve instead of the flow channel switching valve 74. In this case, a flow rate of the second heat medium flowing to the motor generator MG and a flow rate of the second heat medium flowing to the combined heat exchanger 20 can be appropriately adjusted by the flow rate regulation valve.

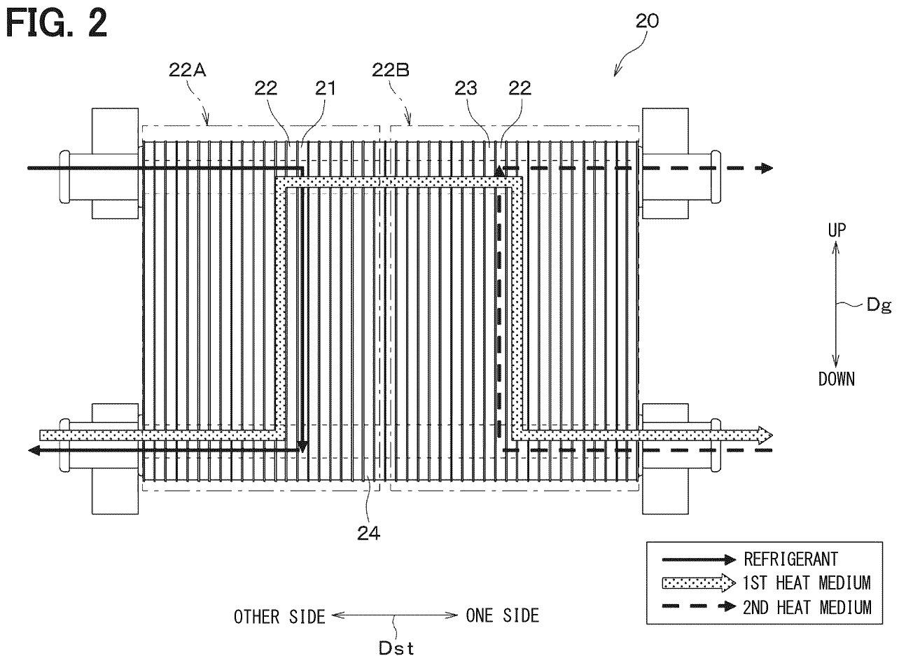

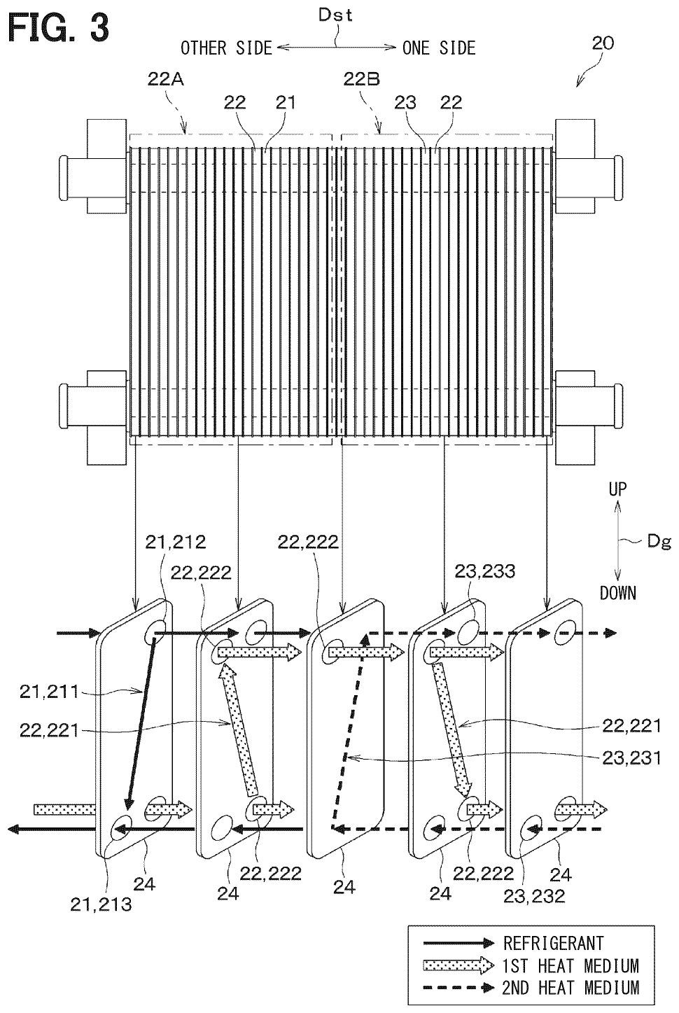

Next, the details of the combined heat exchanger 20 will be described with reference to FIGS. 2 and 3. The arrows indicating up and down in FIGS. 2 and 3 indicate a vertical direction Dg when the combined heat exchanger 20 is mounted in a vehicle.

As shown in FIGS. 2 and 3, the combined heat exchanger 20 is configured as a plate stacking type heat exchanger. The combined heat exchanger 20 is formed by stacking and joining numerous plate-shaped members 24. The combined heat exchanger 20 is mounted in the vehicle in such a posture in which a stacking direction Dst of the numerous plate-shaped members 24 intersects with the vertical direction Dg.

The numerous plate-shaped members 24 are elongated, substantially rectangular plate materials. The plate-shaped member 24 is formed by cladding a brazing material on both sides of a metal core material including an aluminum alloy or the like. The core material of the plate-shaped member 24 has a sacrificial layer formed on at least one surface. The sacrificial layer includes an aluminum alloy containing a predetermined proportion of a material (for example, Zn) having lower electric potential than the core material. With this configuration, the sacrificial layer corrodes preferentially over the core material, so that corrosion of the core material is less likely to progress. As a result, corrosion resistance of the combined heat exchanger 20 is improved.

The plate-shaped member 24 has a protrusion portion that protrudes toward one side of the combined heat exchanger 20 in the stacking direction Dst, at an edge portion which is an outer periphery thereof. The numerous plate-shaped members 24 are stacked on top of one another, with their protrusion portions joined together by brazing.

By stacking and joining the numerous plate-shaped members 24 on top of each other, the refrigerant flow channel portion 21 through which the refrigerant flows, the first heat medium flow channel portion 22 through which the first heat medium flows, and the second heat medium flow channel portion 23 through which the second heat medium flows are formed.

The refrigerant flow channel portion 21 has multiple refrigerant flow channels 211 formed between adjacent plate-shaped members 24, a refrigerant distributing portion 212 that distributes the refrigerant to the multiple refrigerant flow channels 211, and a refrigerant collecting portion 213 that collects the refrigerant that has passed through the multiple refrigerant flow channels 211. The multiple refrigerant flow channels 211 are heat exchanging parts that exchange heat between the refrigerant and the first heat medium, and extend along plate surfaces of the plate-shaped members 24. The refrigerant distributing portion 212 and the refrigerant collecting portion 213 are formed by joining together cylindrical portions, each having a substantially cylindrical shape, provided on the plate-shaped members 24. The refrigerant distributing portion 212 and the refrigerant collecting portion 213 extend in the stacking direction Dst.

In the refrigerant flow channel portion 21, the refrigerant distributing portion 212 is formed above the refrigerant flow channels 211, and the refrigerant collecting portion 213 is formed below the refrigerant flow channels 211. In this manner, the refrigerant flow channel portion 21 is configured such that the refrigerant flows downward.

Specifically, the refrigerant flow channel portion 21 is formed by plate-shaped members 24 in a part of the combined heat exchanger 20 on the other side in the stacking direction Dst, out of the numerous plate-shaped members 24. The refrigerant flow channel portion 21 is disposed adjacent to the first heat medium flow channel portion 22 to directly transfer the heat of the refrigerant to the first heat medium. The refrigerant flow channel portion 21 is disposed such that the entire refrigerant flow channel 211, which is the heat exchanging part, is in thermal contact with the first heat medium flow channel portion 22.

The second heat medium flow channel portion 23 has multiple second heat medium flow channels 231 formed between adjacent plate-shaped members 24, a second heat medium distributing portion 232 that distributes the second heat medium to the second heat medium flow channels 231, and a second heat medium collecting portion 233 that collects the second heat medium that has passed through the second heat medium flow channels 231.

The second heat medium flow channels 231 are heat exchanging parts that exchange heat between the second heat medium and the first heat medium, and extend along the plate surfaces of the plate-shaped members 24. The second heat medium distributing portion 232 and the second heat medium collecting portion 233 are formed by joining together cylindrical portions, each having a substantially cylindrical shape, provided on the plate-shaped members 24. The second heat medium distributing portion 232 and the second heat medium collecting portion 233 extend in the stacking direction Dst.

In the second heat medium flow channel portion 23, the second heat medium distributing portion 232 is formed below the second heat medium flow channels 231, and the second heat medium collecting portion 233 is formed above the second heat medium flow channels 231. In this manner, the second heat medium flow channel portion 23 is configured such that the second heat medium flows upward.

Specifically, the second heat medium flow channel portion 23 is formed by plate-shaped members 24 in a part of the combined heat exchanger 20 on the one side in the stacking direction Dst, out of the numerous plate-shaped members 24. The second heat medium flow channel portion 23 is disposed adjacent to the first heat medium flow channel portion 22 to indirectly transfer the heat of the refrigerant via the first heat medium. The second heat medium flow channel portion 23 is disposed such that the entire second heat medium flow channel 231, which is heat exchanging part, is in thermal contact with the first heat medium flow channel portion 22.

The first heat medium flow channel portion 22 has multiple first heat medium flow channels 221 formed between adjacent plate-shaped members 24, and a tank unit 222 that distributes the first heat medium to the multiple first heat medium flow channels 221 and collects the refrigerant that has passed through the multiple first heat medium flow channels 221.

The first heat medium flow channels 221 are heat exchanging parts that exchange heat between the first heat medium and the refrigerant or the second heat medium, and extend along the plate surfaces of the plate-shaped members 24. The tank unit 222 is formed by joining together cylindrical portions, each having a substantially cylindrical shape, provided on the plate-shaped members 24. The tank unit 222 extends in the stacking direction Dst.

The first heat medium flow channel portion 22 has a first heat exchanging unit 22A that exchanges heat between the first heat medium and the refrigerant, and a second heat exchanging unit 22B that exchanges heat between the first heat medium and the second heat medium. The first heat medium flow channel portion 22 is configured such that the first heat medium flows through the first heat exchanging unit 22A and then the second heat exchanging unit 22B.

In the first heat exchanging unit 22A, first heat medium flow channels 221 and refrigerant flow channels 211 are arranged alternately. The first heat medium flow channel 221 forming the first heat exchanging unit 22A is configured such that the first heat medium flows upward. Accordingly, in the refrigerant flow channel portion 21 and the first heat medium flow channel portion 22, the refrigerant and the first heat medium flow in countercurrent flow.

In the second heat exchanging unit 22B, the first heat medium flow channels 221 and the second heat medium flow channels 231 are arranged alternately. The first heat medium flow channel 221 forming the second heat exchanging unit 22B is configured such that the first heat medium flows downward. Accordingly, in the first heat medium flow channel portion 22 and the second heat medium flow channel portion 23, the first heat medium and the second heat medium flow in countercurrent flow.

In the first heat medium flow channel portion 22, a flow direction of the first heat medium in the first heat exchanging unit 22A is opposite to a flow direction of the first heat medium in the second heat exchanging unit 22B. That is, the first heat medium flow channel portion 22 has a structure in which the flow of the first heat medium makes a U-turn.

In the combined heat exchanger 20 of the present embodiment, the refrigerant flows downward through the refrigerant flow channel portion 21, and the second heat medium flows upward through the second heat medium flow channel portion 23. Accordingly, in the refrigerant flow channel portion 21 and the second heat medium flow channel portion 23, the refrigerant and the second heat medium flow in countercurrent flow.

The heat exchange system 1 including the combined heat exchanger 20 configured as above includes the control unit 100 for controlling various component devices, as shown in FIG. 1. The control unit 100 includes a microcomputer including a processor and a memory, and its peripheral circuit. The control unit 100 executes various calculations and processes based on a control program stored in the memory. A non-transitory tangible storage medium forms the memory of the control unit 100.

The compressor 11, the first depressurization valve 15, the second depressurization valve 18, the high-temperature side pump 51, the electric heater 52, the high-temperature side switching valve 55, the first circulation pump 61, the second circulation pump 71, the flow channel switching valve 74, and the like are connected to an output side of the control unit 100.

The heat exchange system 1 can change the flow rate of the refrigerant flowing through the refrigerant flow channel portion 21, the flow rate of the first heat medium flowing through the first heat medium flow channel portion 22, and the flow rate of the second heat medium flowing through the second heat medium flow channel portion 23 by changing operations of the second depressurization valve 18, each of the circulation pumps 61 and 71, and the flow channel switching valve 74. In the present embodiment, the second depressurization valve 18, each of the circulation pumps 61 and 71, and the flow channel switching valve 74 forms a flow rate adjustment unit that adjusts the flow rate of the refrigerant flowing through the refrigerant flow channel portion 21, the flow rate of the first heat medium flowing through the first heat medium flow channel portion 22, and the flow rate of the second heat medium flowing through the second heat medium flow channel portion 23.

Although not shown, an air conditioning control sensor group and a device temperature control sensor group are connected to an input side of the control unit 100. Various operation switches are connected to the input side of the control unit 100, and operation signals of the various operation switches are input.

The various operation switches include an air conditioner switch, a room temperature adjustment switch, and the like. The air conditioner switch is a switch for setting whether the air conditioning unit 40 cools the air. The room temperature adjustment switch is a switch for setting a set temperature inside the vehicle compartment.

The control unit 100 switches an operation mode of the heat exchange system 1 based on sensor output of the air conditioning control sensor group and the device temperature control sensor group, the operation signals of the various operation switches, and the like.

The control unit 100, for example, calculates a target blowing temperature of the air conditioning wind being blown from the air conditioning unit 40 into the vehicle compartment, and switches the operation mode of the heat exchange system 1 to any one of a cooling mode, a heating mode, or a dehumidification heating mode based on the target blowing temperature and the like.

An operation of the cooling mode, the heating mode, and dehumidification heating mode will be described below.

### (Cooling Mode)

When a condition for executing the cooling mode is met, the control unit 100 determines control signals to be output to the various devices connected to the control unit 100 based on the target blowing temperature, the sensor output of the various sensor groups, and the like.

The control unit 100, for example, drives the compressor 11, controls the first depressurization valve 15 to a throttle state, and controls the second depressurization valve 18 to a fully closed state. The control unit 100 determines the control signal to be output to the first depressurization valve 15 such that a degree of superheat on the refrigerant outlet side of the air conditioning evaporator 16 becomes a predetermined first target degree of superheat. The control unit 100 drives the high-temperature side pump 51 and controls the high-temperature side switching valve 55 such that the high-temperature side heat medium flows to the high-temperature side radiator 53.

In the refrigeration cycle 10 in the cooling mode, the refrigerant discharged from the compressor 11 flows into the condenser 12. The refrigerant that has flowed into the condenser 12 dissipates heat to the high-temperature side heat medium flowing through the high-temperature side circuit 50. Accordingly, the refrigerant flowing through the condenser 12 is cooled and condensed. The high-temperature side heat medium dissipates heat to the outside air when passing through the high-temperature side radiator 53.

The refrigerant that has passed through the condenser 12 is separated into the gas and liquid phases in the liquid receiving unit 13, and the liquid-phase refrigerant that is excessive in the cycle is stored inside the liquid receiving unit 13. The liquid-phase refrigerant stored in the liquid receiving unit 13 is subcooled in the subcooling unit 14 by exchanging heat with the high-temperature side heat medium before passing through the condenser 12.

The liquid-phase refrigerant that has passed through the subcooling unit 14 is depressurized in the first depressurization valve 15. The refrigerant depressurized in the first depressurization valve 15 flows into the air conditioning evaporator 16 and absorbs heat from the air being blown into the vehicle compartment and evaporates. Accordingly, the air being blown into the vehicle compartment is cooled to a desired temperature. Then, the refrigerant that has passed through the air conditioning evaporator 16 flows to an intake side of the compressor 11 and is compressed again by the compressor 11.

As described above, in the cooling mode, heat is exchanged between the refrigerant and the air being blown into the vehicle compartment in the air conditioning evaporator 16, thereby cooling the air being blown into the vehicle compartment. Accordingly, the inside of the vehicle compartment is cooled.

### (Device Cooling in Cooling Mode)

In the cooling mode, when conditions for cooling at least some of the heat generating elements 64 and 73 are met, the control unit 100 drives at least one of the first circulation pump 61 and the second circulation pump 71, and controls the second depressurization valve 18 to a throttle state.

For example, when the condition for cooling the first heat generating element 64 is met, the control unit 100 drives the first circulation pump 61 in a state in which the second circulation pump 71 is stopped, and controls the second depressurization valve 18 to the throttle state. In this case, a portion of the refrigerant that has passed through the subcooling unit 14 flows into the second depressurization valve 18 and is depressurized. The refrigerant depressurized by the second depressurization valve 18 absorbs heat from the first heat medium flowing through the first heat medium flow channel portion 22 in the refrigerant flow channel portion 21 of the combined heat exchanger 20 and evaporates. Accordingly, the first heat medium flowing through the first heat medium circuit 60 is cooled. The first heat medium cooled by the combined heat exchanger 20 circulates through the first heat medium circuit 60, thereby cooling the first heat generating element 64.

### (Battery Cooling in Cooling Mode)

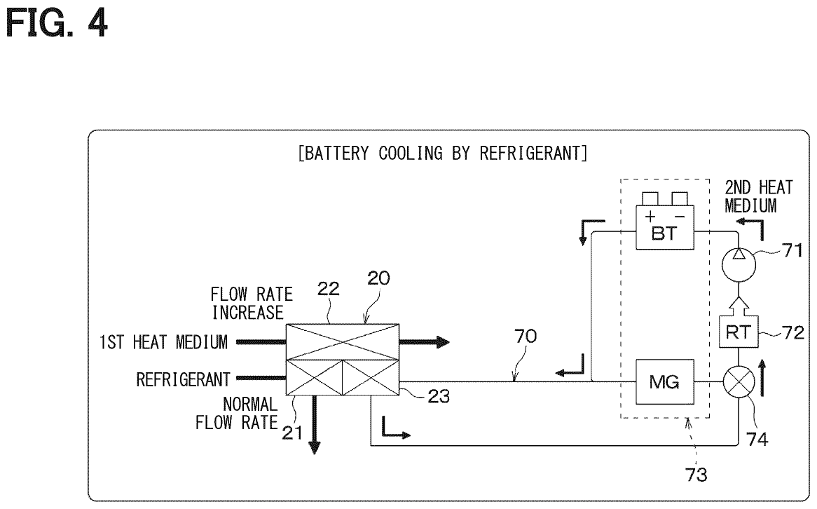

For example, when a battery cooling condition for cooling the battery BT of the second heat generating element 73 is met, the control unit 100 drives each of the circulation pumps 61 and 71 and controls the second depressurization valve 18 to the throttle state. In addition, as shown in FIG. 4, the control unit 100 controls the flow channel switching valve 74 such that the second heat medium pumped out from the second circulation pump 71 flows in an order of the battery BT→the second heat medium flow channel portion 23 of the combined heat exchanger 20. The control unit 100 controls the first circulation pump 61 such that the flow rate of the first heat medium flowing through the combined heat exchanger 20 is increased compared to the flow rate before the battery cooling condition is met.

In this case, a portion of the refrigerant that has passed through the subcooling unit 14 flows into the second depressurization valve 18 and is depressurized. The refrigerant depressurized by the second depressurization valve 18 absorbs heat from the first heat medium flowing through the first heat medium flow channel portion 22 in the refrigerant flow channel portion 21 of the combined heat exchanger 20 and evaporates. In the combined heat exchanger 20, the second heat medium is cooled by heat exchange between the first heat medium and the second heat medium. Accordingly, the second heat medium cooled by the combined heat exchanger 20 circulates through the second heat medium circuit 70, thereby cooling the battery BT of the second heat generating element 73.

### (Battery Heating in Cooling Mode)

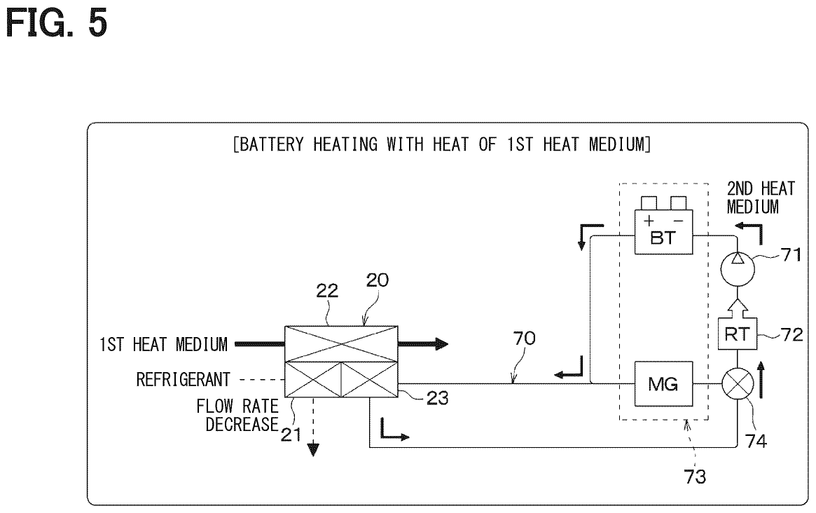

On the other hand, in the cooling mode, when a battery heating condition for heating the battery BT of the second heat generating element 73 is met, the control unit 100 heats the battery BT by using the heat of the first heat medium. The control unit 100, for example, drives each of the circulation pump 61 and 71 and controls the second depressurization valve 18 to a small throttle opening degree or to the fully closed state such that the flow rate of the refrigerant flowing through the refrigerant flow channel portion 21 of the combined heat exchanger 20 is reduced. In addition, as shown in FIG. 5, the control unit 100 controls the flow channel switching valve 74 such that the second heat medium pumped out from the second circulation pump 71 flows in the order of the battery BT→the second heat medium flow channel portion 23 of the combined heat exchanger 20.

In this case, the first heat medium, which has received heat from the first heat generating element 64 and has been heated, flows into the first heat medium flow channel portion 22 of the combined heat exchanger 20. Since the flow rate of the refrigerant flowing through the refrigerant flow channel portion 21 is low, in the combined heat exchanger 20, heat exchange is predominant between the first heat medium and the second heat medium. Therefore, the first heat medium that has flowed into the first heat medium flow channel portion 22 dissipates heat through heat exchange with the second heat medium flowing through the second heat medium flow channel portion 23. In other words, the second heat medium flowing through the second heat medium flow channel portion 23 receives heat from the first heat medium and is heated. Accordingly, the second heat medium that has been heated in the combined heat exchanger 20 circulates through the second heat medium circuit 70, thereby heating the battery BT of the second heat generating element 73.

### (Heating Mode)

When a condition for executing the heating mode is met, the control unit 100 determines control signals to be output to the various devices connected to the control unit 100 based on the target blowing temperature, the sensor output of the various sensor groups, and the like.

The control unit 100, for example, drives the compressor 11, controls the first depressurization valve 15 to a fully closed state, and controls the second depressurization valve 18 to the throttle state. The control unit 100 determines the control signal to be output to the second depressurization valve 18 such that a degree of superheat on the refrigerant outlet side of the combined heat exchanger 20 becomes a predetermined second target degree of superheat. The control unit 100 drives the high-temperature side pump 51 and controls the high-temperature side switching valve 55 such that the high-temperature side heat medium flows through the heater core 54. The control unit 100 drives the first circulation pump 61 such that the first heat medium flows through the low-temperature side radiator 63.

In the refrigeration cycle 10 in the heating mode, the refrigerant discharged from the compressor 11 flows into the condenser 12. The refrigerant that has flowed into the condenser 12 dissipates heat to the high-temperature side heat medium flowing through the high-temperature side circuit 50. Accordingly, the refrigerant flowing through the condenser 12 is cooled and condensed. The high-temperature side heat medium dissipates heat to the air being blown into the vehicle compartment by the heater core 54. Accordingly, the air being blown into the vehicle compartment is heated.

The refrigerant that has passed through the condenser 12 is separated into the gas and liquid phases in the liquid receiving unit 13, and the liquid-phase refrigerant that is excessive in the cycle is stored inside the liquid receiving unit 13. The liquid-phase refrigerant stored in the liquid receiving unit 13 is subcooled in the subcooling unit 14 by exchanging heat with the high-temperature side heat medium before passing through the condenser 12.

The liquid-phase refrigerant that has passed through the subcooling unit 14 is depressurized in the second depressurization valve 18. The refrigerant depressurized in the second depressurization valve 18 flows into the refrigerant flow channel portion 21 of the combined heat exchanger 20, and absorbs heat from the first heat medium flowing through the first heat medium flow channel portion 22 and evaporates. Then, the refrigerant that has passed through the combined heat exchanger 20 flows to the intake side of the compressor 11 and is compressed again by the compressor 11.

The first heat medium that has passed through the first heat medium flow channel portion 22 of the combined heat exchanger 20 absorbs heat from the outside air when passing through the low-temperature side radiator 63. Therefore, the refrigerant flowing through the refrigerant flow channel portion 21 of the combined heat exchanger 20 absorbs heat from the outside air via the first heat medium.

The first heat medium absorbs heat also from the first heat generating element 64 when passing through the first heat generating element 64. In this case, the refrigerant flowing through the refrigerant flow channel portion 21 of the combined heat exchanger 20 absorbs heat also from the first heat generating element 64 via the first heat medium.

As described above, in the heating mode, the refrigerant discharged from the compressor 11 is caused to dissipate heat to the high-temperature side heat medium by the condenser 12 and the subcooling unit 14, and the high-temperature side heat medium of the high-temperature side circuit 50 is caused to dissipate heat to the air being blown into the vehicle compartment by the heater core 54, thereby heating the air being blown into the vehicle compartment. Accordingly, the inside of the vehicle compartment is heated.

In the heating mode, the first heat medium flowing through the low-temperature side radiator 63 absorbs heat from the outside air, so that frost may be formed on the low-temperature side radiator 63. When frost is formed on the low-temperature side radiator 63, heat exchange between the first heat medium and the outside air is restricted.

In contrast to this, the low-temperature side radiator 63 of the present embodiment is connected to the high-temperature side radiator 53 via the common heat transfer fin to be capable of transferring heat. Therefore, for example, when the vehicle is stopped after the heating mode is executed, the heat remaining in the high-temperature side heat medium in the high-temperature side circuit 50 can be used to defrost the low-temperature side radiator 63.

### (Battery Cooling in Heating Mode)

In the heating mode, when the battery cooling condition for cooling the battery BT of the second heat generating element 73 is met, the control unit 100 drives the second circulation pump 71. The control unit 100 controls the flow channel switching valve 74 such that the second heat medium pumped out from the second circulation pump 71 flows in the order of the battery BT→the second heat medium flow channel portion 23 of the combined heat exchanger 20. The control unit 100 controls the first circulation pump 61 such that the flow rate of the first heat medium flowing through the combined heat exchanger 20 is increased compared to the flow rate before the battery cooling condition is met.

In this case, The refrigerant depressurized by the second depressurization valve 18 absorbs heat from the first heat medium flowing through the first heat medium flow channel portion 22 in the refrigerant flow channel portion 21 of the combined heat exchanger 20 and evaporates. In the combined heat exchanger 20, the second heat medium is cooled by heat exchange between the first heat medium and the second heat medium. Accordingly, the second heat medium cooled by the combined heat exchanger 20 circulates through the second heat medium circuit 70, thereby cooling the battery BT of the second heat generating element 73.

### (Battery Heating in Heating Mode)

On the other hand, in the heating mode, when the battery heating condition for heating the battery BT of the second heat generating element 73 is met, the control unit 100 heats the battery BT. As described above, in the heating mode, the first heat medium is caused to dissipate heat to the refrigerant by the combined heat exchanger 20. For this reason, in the heating mode, it may be difficult to sufficiently heat the battery BT by using the heat of the first heat medium.

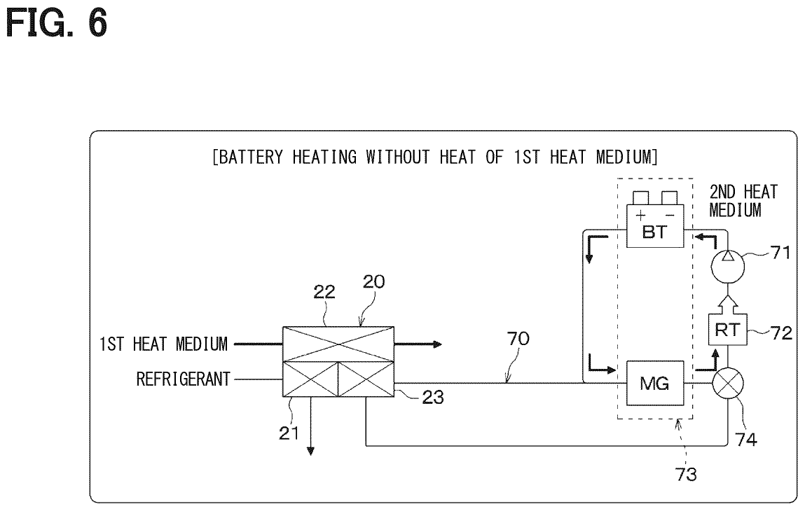

Taking this into consideration, in the heating mode, the control unit 100 heats the battery BT without using the heat of the first heat medium. The control unit 100, for example, drives the each of the circulation pumps 61 and 71 and controls the second depressurization valve 18 to the throttle state. As shown in FIG. 6, the control unit 100 controls the flow channel switching valve 74 such that the second heat medium pumped out from the second circulation pump 71 flows in the order of the battery BT→the motor generator MG.

In this case, the second heat medium, which has received heat from the motor generator MG and has been heated, can be caused to dissipate heat by the battery BT. That is, the battery BT of the second heat generating element 73 is heated by the second heat medium which has received heat from the motor generator MG and has been heated.

When the temperature of the first heat medium after heat exchange with the refrigerant in the combined heat exchanger 20 is higher than the temperature of the battery BT, it is possible to heat the battery by using the heat of the first heat medium. In this case, as in the cooling mode, the battery may be heated by using the heat of the first heat medium. However, when the flow rate of the refrigerant flowing through the combined heat exchanger 20 in the heating mode is reduced, the amount of heat absorbed by the refrigerant in the combined heat exchanger 20 is decreased. Therefore, in the heating mode, it is desirable to control the second depressurization valve 18 such that the flow rate of the refrigerant flowing through the combined heat exchanger 20 is not decreased.

### (Dehumidification Heating Mode)

When a condition for executing the dehumidification heating mode is met, the control unit 100 determines control signals to be output to the various devices connected to the control unit 100 based on the target blowing temperature, the sensor output of the various sensor groups, and the like.

The control unit 100, for example, drives the compressor 11, controls the first depressurization valve 15 to a throttle state, and controls the second depressurization valve 18 to the fully closed state. The control unit 100 determines the control signal to be output to the first depressurization valve 15 such that a degree of superheat on the refrigerant outlet side of the air conditioning evaporator 16 becomes a predetermined third target degree of superheat. The control unit 100 drives the high-temperature side pump 51 and controls the high-temperature side switching valve 55 such that the high-temperature side heat medium flows through the heater core 54.

In the refrigeration cycle 10 in the dehumidification heating mode, the refrigerant discharged from the compressor 11 flows into the condenser 12. The refrigerant that has flowed into the condenser 12 dissipates heat to the high-temperature side heat medium flowing through the high-temperature side circuit 50. Accordingly, the refrigerant flowing through the condenser 12 is cooled and condensed. The high-temperature side heat medium dissipates heat to the air being blown into the vehicle compartment by the heater core 54. Accordingly, the air being blown into the vehicle compartment is heated.

The refrigerant that has passed through the condenser 12 is separated into the gas and liquid phases in the liquid receiving unit 13, and the liquid-phase refrigerant that is excessive in the cycle is stored inside the liquid receiving unit 13. The liquid-phase refrigerant stored in the liquid receiving unit 13 is subcooled in the subcooling unit 14 by exchanging heat with the high-temperature side heat medium before passing through the condenser 12.

The liquid-phase refrigerant that has passed through the subcooling unit 14 is depressurized in the second depressurization valve 18. The refrigerant depressurized in the first depressurization valve 15 flows into the air conditioning evaporator 16 and absorbs heat from the air before being heated by the heater core 54 and evaporates. Accordingly, the air being blown into the vehicle compartment is dehumidified. Then, the refrigerant that has passed through the air conditioning evaporator 16 flows to an intake side of the compressor 11 and is compressed again by the compressor 11.

As described above, in the dehumidification heating mode, the refrigerant discharged from the compressor 11 is caused to dissipate heat to the high-temperature side heat medium by the condenser 12 and the subcooling unit 14, and the high-temperature side heat medium of the high-temperature side circuit 50 is caused to dissipate heat to the air being blown into the vehicle compartment by the heater core 54. In the dehumidification heating mode, the refrigerant depressurized in the first depressurization valve 15 is evaporated by the air conditioning evaporator 16 through heat exchange with the air blown into the vehicle compartment. Accordingly, the air dehumidified by the air conditioning evaporator 16 can be heated by the heater core 54 and blown into the vehicle compartment.

### (Device Cooling in Dehumidification Heating Mode)

In the dehumidification heating mode, when a condition for cooling at least some of the heat generating elements 64 and 73 is met, the control unit 100 drives at least one of the first circulation pump 61 and the second circulation pump 71, and controls the second depressurization valve 18 to the throttle state.

For example, when the condition for cooling the first heat generating element 64 is met, the control unit 100 drives the first circulation pump 61 in a state in which the second circulation pump 71 is stopped, and controls the second depressurization valve 18 to the throttle state. In this case, a portion of the refrigerant that has passed through the subcooling unit 14 flows into the second depressurization valve 18 and is depressurized. The refrigerant depressurized by the second depressurization valve 18 absorbs heat from the first heat medium flowing through the first heat medium flow channel portion 22 in the refrigerant flow channel portion 21 of the combined heat exchanger 20 and evaporates. Accordingly, the first heat medium flowing through the first heat medium circuit 60 is cooled. The first heat medium cooled by the combined heat exchanger 20 circulates through the first heat medium circuit 60, thereby cooling the first heat generating element 64.

For example, when the battery cooling condition for cooling the battery BT of the second heat generating element 73 is met, the control unit 100 drives each of the circulation pumps 61 and 71 and controls the second depressurization valve 18 to the throttle state. The control unit 100 controls the flow channel switching valve 74 such that the second heat medium pumped out from the second circulation pump 71 flows in the order of the battery BT→the second heat medium flow channel portion 23 of the combined heat exchanger 20. The control unit 100 controls the first circulation pump 61 such that the flow rate of the first heat medium flowing through the combined heat exchanger 20 is increased compared to the flow rate before the battery cooling condition is met.

In this case, a portion of the refrigerant that has passed through the subcooling unit 14 flows into the second depressurization valve 18 and is depressurized. The refrigerant depressurized by the second depressurization valve 18 absorbs heat from the first heat medium flowing through the first heat medium flow channel portion 22 in the refrigerant flow channel portion 21 of the combined heat exchanger 20 and evaporates. In the combined heat exchanger 20, the second heat medium is cooled by heat exchange between the first heat medium and the second heat medium. Accordingly, the second heat medium cooled by the combined heat exchanger 20 circulates through the second heat medium circuit 70, thereby cooling the battery BT of the second heat generating element 73.

### (Battery Heating in Dehumidification Heating Mode)

On the other hand, in the dehumidification heating mode, when the battery heating condition for heating the battery BT of the second heat generating element 73 is met, the control unit 100 heats the battery BT by using the heat of the first heat medium, as in the cooling mode. The control unit 100, for example, drives each of the circulation pump 61 and 71 and controls the second depressurization valve 18 to the small throttle opening degree or to the fully closed state such that the flow rate of the refrigerant flowing through the refrigerant flow channel portion 21 of the combined heat exchanger 20 is reduced. The control unit 100 controls the flow channel switching valve 74 such that the second heat medium pumped out from the second circulation pump 71 flows in the order of the battery BT→the second heat medium flow channel portion 23 of the combined heat exchanger 20.

In this case, the first heat medium, which has received heat from the first heat generating element 64 and has been heated, flows into the first heat medium flow channel portion 22 of the combined heat exchanger 20. The first heat medium flowing into the first heat medium flow channel portion 22 dissipates heat through heat exchange with the second heat medium flowing through the second heat medium flow channel portion 23. Accordingly, the second heat medium flowing through the second heat medium flow channel portion 23 receives heat from the first heat medium and is heated. The second heat medium heated by the combined heat exchanger 20 circulates through the second heat medium circuit 70, thereby heating the battery BT of the second heat generating element 73.

The heat exchange system 1 described above includes the combined heat exchanger 20 that exchanges heat between a refrigerant circulating through the refrigeration cycle 10, the first heat medium flowing through the first heat medium circuit 60 including the first heat generating element 64, and the second heat medium flowing through the second heat medium circuit 70 including the second heat generating element 73. The combined heat exchanger 20 includes the refrigerant flow channel portion 21 through which the refrigerant flows, the first heat medium flow channel portion 22 through which the first heat medium flows, and the second heat medium flow channel portion 23 through which the second heat medium flows. The refrigerant flow channel portion 21, the first heat medium flow channel portion 22, and the second heat medium flow channel portion 23 are disposed such that the heat of the refrigerant is transferred to both the first heat medium and the second heat medium.

According to the combined heat exchanger 20 of the present disclosure, heat can be exchanged between three types of fluids, namely, the refrigerant, the first heat medium, and the second heat medium, in the single heat exchanger. Therefore, the heat of the refrigerant can be supplied to the first heat medium and the second heat medium while reducing the complication of the cycle configuration of the refrigeration cycle 10. The combined heat exchanger 20 of the present disclosure allows cost reduction and downsizing. The cycle configuration and a circuit configuration are compact, making it possible to reduce heat loss.

The combined heat exchanger 20 of the present embodiment has the following features.

(1) The first heat medium is a liquid-phase fluid that does not change a phase when flowing through the first heat medium circuit 60. The first heat medium flow channel portion 22 is disposed adjacent to the refrigerant flow channel portion 21 to directly transfer the heat of the refrigerant to the first heat medium. The second heat medium flow channel portion 23 is disposed adjacent to the first heat medium flow channel portion 22 to indirectly transfer the heat of the refrigerant to the second heat medium via the first heat medium. In this way, when the structure is such that the heat of the refrigerant is transferred to the first heat medium, which is a liquid-phase fluid with a large heat capacity, and the heat of the refrigerant is transferred to the second heat medium via the first heat medium, the heat of the refrigerant can be appropriately supplied to both the first heat medium and the second heat medium.

(2) The first heat medium flow channel portion 22 and the second heat medium flow channel portion 23 are disposed adjacent to each other to transfer heat of the first heat generating element 64 to the second heat medium via the first heat medium. In this way, it is possible to adjust a temperature of the second heat generating element 73 by using not only the heat of the refrigerant but also the heat of the first heat generating element 64. This effect is unique to the present invention and cannot be achieved by adding a heat exchanger that exchanges heat between the refrigerant and the first heat medium and a heat exchanger that exchanges heat between the refrigerant and the second heat medium to the refrigeration cycle 10.

(3) The refrigeration cycle 10 includes the compressor 11 that compresses and discharges the refrigerant, the condenser 12 and the subcooling unit 14 that dissipate heat of the refrigerant discharged from the compressor 11, and the second depressurization valve 18 that depressurizes the refrigerant that has passed through the subcooling unit 14. The refrigerant flow channel portion 21 forms an evaporation portion that evaporates the refrigerant depressurized in the second depressurization valve 18. The refrigerant flow channel portion 21 transfers the cold energy of the refrigerant to both the first heat medium and the second heat medium. According to this, it is possible to appropriately cool the first heat generating element 64 or the second heat generating element 73 by absorbing heat from the first heat medium or the second heat medium by latent heat of evaporation of the refrigerant.

(4) The first heat medium circuit 60 is provided with the low-temperature side radiator 63 that exchanges heat between the first heat medium and the outside air. According to this, it is possible to transfer the heat of the outside air and the heat of the first heat generating element 64 to the refrigerant via the first heat medium, and it is possible to cause the refrigeration cycle 10 to function as a heat pump cycle that absorbs heat from the outside air or the like.

(5) The second heat generating element 73 includes the battery BT as a heat generating body. This makes it possible to adjust the temperature of the battery BT by using the heat of the refrigerant and the heat of the first heat medium.

(6) The second heat generating element 73 includes multiple heat generating bodies, such as the battery BT and the motor generator MG. The second heat medium circuit 70 is configured to transfer heat of a heat generating body among the multiple heat generating bodies to another heat generating body other than the heat generating body via the second heat medium. This makes it possible to adjust a temperature of the other heat generating body by using the heat of the heat generating body among the multiple heat generating bodies, in the second heat medium circuit 70.

Specifically, the second heat medium circuit 70 is provided with the flow channel switching valve 74 for switching the second heat medium pumped out from the second circulation pump 71 between the flow channel through which the second heat medium flows in the order of the battery BT→second heat medium flow channel portion 23, and the flow channel through which the second heat medium flows in the order of the battery BT→motor generator MG. Accordingly, the second heat medium circuit 70 is capable of adjusting the temperature of the battery BT not only by using the heat of the refrigerant or the heat of the first heat medium, but also by using the heat of the heat generating body such as the motor generator MG.

(7) The second heat medium has a higher electrical insulation property than the first heat medium. According to this, leakage of electricity of the second heat generating element via the second heat medium is reduced, thereby making it possible to safely adjust the temperature of the battery BT or the like included in the second heat generating element 73 via the second heat medium.

(8) The refrigerant flow channel portion 21 is adjacent to the first heat medium flow channel portion 22 to directly transfer the heat of the refrigerant to the first heat medium, and is disposed such that an entire heat exchanging part in the refrigerant flow channel portion 21 is in thermal contact with the first heat medium flow channel portion 22. This makes it possible to promote heat exchange between the refrigerant flowing through the refrigerant flow channel portion 21 and the first heat medium flowing through the first heat medium flow channel portion 22.

The refrigerant flow channel portion 21 of the present embodiment is configured as an evaporation portion that evaporates the refrigerant, and is therefore structured to promote heat exchange between the refrigerant and the first heat medium, making it easier to evaporate the refrigerant in the refrigerant flow channel portion 21. As a result, liquid backflow to the compressor 11 is reduced, and the compressor 11 can be protected.

(9) The first heat medium flow channel portion 22 has the first heat exchanging unit 22A that exchanges heat between the first heat medium and the refrigerant, and the second heat exchanging unit 22B that exchanges heat between the first heat medium and the second heat medium, and is configured such that the first heat medium flows in an order of the first heat exchanging unit 22A and the second heat exchanging unit 22B. According to this, an entire amount of the first heat medium flows through each of the first heat exchanging unit 22A and the second heat exchanging unit 22B. This makes it possible to ensure a sufficient heat exchange amount between the refrigerant and the first heat medium in the first heat exchanging unit 22A and a sufficient heat exchange amount between the first heat medium and the second heat medium in the second heat exchanging unit 22B.

(10) The refrigerant includes refrigerator oil. The refrigerant flow channel portion 21 is configured such that the refrigerant flows downward. This makes it possible to reduce the refrigerator oil from accumulating in the combined heat exchanger 20. As a result, a sliding part of the compressor 11 are lubricated by the refrigerator oil, thereby making it possible to protect the compressor 11.

(11) The refrigerant flow channel portion 21 and the first heat medium flow channel portion 22 are disposed such that the refrigerant and the first heat medium flow in countercurrent flow. The first heat medium flow channel portion 22 and the second heat medium flow channel portion 23 are disposed such that the first heat medium and the second heat medium flow in countercurrent flow. This makes it possible to ensure a temperature difference between the refrigerant and the first heat medium and a temperature difference between the first heat medium and the second heat medium to appropriately exchange heat between the refrigerant, the first heat medium, and the second heat medium.

(12) In addition to the combined heat exchanger 20, the heat exchange system 1 includes a flow rate adjustment unit that adjusts the flow rate of the refrigerant flowing through the refrigerant flow channel portion 21, the flow rate of the first heat medium flowing through the first heat medium flow channel portion 22, and the flow rate of the second heat medium flowing through the second heat medium flow channel portion 23. The refrigerant flow channel portion 21, the first heat medium flow channel portion 22, and the second heat medium flow channel portion 23 are disposed such that the heat of the refrigerant is transferred to both the first heat medium and the second heat medium. According to this, in the single heat exchanger, heat can be mutually exchanged between three types of fluids, namely, the refrigerant, the first heat medium, and the second heat medium, while adjusting the flow rates of the three types of fluids. Therefore, the heat of the refrigerant can be supplied to the first heat medium and the second heat medium while reducing the complication of the cycle configuration of the refrigeration cycle 10.

(13) The first heat medium flow channel portion 22 is disposed adjacent to the refrigerant flow channel portion 21 to directly transfer the heat of the refrigerant to the first heat medium. The second heat medium flow channel portion 23 is disposed adjacent to the first heat medium flow channel portion 22 to indirectly transfer the heat of the refrigerant to the second heat medium via the first heat medium. The flow rate adjustment unit increases the flow rate of the first heat medium flowing through the first heat medium flow channel portion 22, when the operation mode is switched to the operation mode in which heat is exchanged between the refrigerant and the second heat medium via the first heat medium. This makes it possible to ensure a sufficient heat exchange amount between the refrigerant and the first heat medium and a sufficient heat exchange amount between the first heat medium and the second heat medium. This contributes to improving heat transfer efficiency in the combined heat exchanger 20.

When the heat exchange system 1 enters the operation mode in which the second heat generating element 73 is cooled using the cold energy of the refrigerant, for example, a discharge capacity for the first heat medium in the first circulation pump 61 is increased by the control unit 100, thereby increasing the flow rate of the first heat medium flowing through the first heat medium flow channel portion 22. Accordingly, it is easier to transfer the cold energy of the refrigerant to the second heat generating element 73 via the first heat medium and the second heat medium, so that the second heat generating element 73 can be appropriately cooled.

(14) The first heat medium flow channel portion 22 and the second heat medium flow channel portion 23 are disposed adjacent to each other to transfer the heat of the first heat generating element 64 to the second heat medium via the first heat medium. The flow rate adjustment unit reduces the flow rate of the refrigerant flowing through the refrigerant flow channel portion 21, when the operation mode is switched to the operation mode in which the heat of the first heat generating element 64 is transferred to the second heat medium. In this way, it is possible to appropriately transfer the heat of the first heat generating element 64 to the second heat medium while reducing the heat exchange between the first heat medium and the refrigerant. This contributes to improving the heat transfer efficiency in the combined heat exchanger 20.

When the heat exchange system 1 enters the operation mode in which the second heat generating element 73 is heated by using the heat of the first heat medium, for example, the control unit 100 controls the second depressurization valve 18 to the small throttle opening degree or to the fully closed state, thereby reducing the flow rate of the refrigerant flowing through the refrigerant flow channel portion 21. Accordingly, it is easier for the heat of the first heat medium to be transferred to the second heat medium rather than to the refrigerant, so that the second heat generating element 73 can be appropriately heated.

### OTHER EMBODIMENTS

Although the representative embodiment of the present disclosure is described above, the present disclosure is not limited to the embodiment described above, and various modifications can be made, for example, as follows.

The air conditioning evaporator 16 of the refrigeration cycle 10 described above is configured to exchange heat between the refrigerant and the air being blown into the vehicle compartment, but is not limited thereto. For example, the air conditioning evaporator 16 may be configured to exchange heat between the refrigerant and a low-temperature side heat medium that exchanges heat with the air being blown into the vehicle compartment in a cooler core. The refrigerant of the refrigeration cycle 10 may be a refrigerant other than HFO-1234yf. The first depressurization valve 15 and the air conditioning evaporator 16 in the refrigeration cycle 10 are not essential. The liquid receiving unit 13 and the subcooling unit 14 of the refrigeration cycle 10 are not essential. The refrigeration cycle 10 may have an accumulator disposed on the refrigerant intake side of the compressor 11 to store the liquid-phase refrigerant. Each of the depressurization valves 15 and 18 may include, for example, a thermal expansion valve capable of adjusting the degree of superheat of the refrigerant at an outlet of the evaporator, instead of an electric variable aperture having a full closing function.

In the above-mentioned high-temperature side circuit 50, the high-temperature side radiator 53 and the heater core 54 are connected in parallel in the flow of the high-temperature side heat medium, but the present invention is not limited to this. For example, the high-temperature side radiator 53 and the heater core 54 may be connected in series in the flow of the high-temperature side heat medium.

The high-temperature side heat medium flowing through the high-temperature side circuit 50 may include a fluid other than the liquid including ethylene glycol or the antifreeze liquid. The electric heater 52 of the high-temperature side circuit 50 is not essential.

The above-described first heat medium circuit 60 is exemplified as including the inverter INV and the transaxle T/A as the first heat generating element 64, but may include a heat generating device other than these (for example, an ECU). The first heat medium flowing through the first heat medium circuit 60 may include a fluid other than the liquid including ethylene glycol or the antifreeze liquid. The first heat medium may be, for example, the same as the refrigerant flowing through the refrigeration cycle 10 or may be the same as the second heat medium flowing through the second heat medium circuit 70.

It is desirable that the high-temperature side radiator 53 and the low-temperature side radiator 63 are connected to each other via the common heat transfer fin to be capable of transferring heat therebetween, but this is not essential. The low-temperature side radiator 63 of the first heat medium circuit 60 is not essential.

The above-described second heat medium circuit 70 is exemplified as including the battery BT and the motor generator MG as the second heat generating element 73, but may include a heat generating device other than these (for example, an ECU). The second heat medium flowing through the second heat medium circuit 70 is desirably one having a high electrical insulation property, but is not limited to this. The second heat medium may be, for example, the same as the refrigerant flowing through the refrigeration cycle 10 or the same as the first heat medium flowing through the first heat medium circuit 60.

The above-described combined heat exchanger 20 is exemplified as being configured as a plate stacking type heat exchanger formed by stacking the numerous plate-shaped members 24, but is not limited thereto. For example, the combined heat exchanger 20 may be configured as a multi-pipe type heat exchanger having a shell and numerous heat transfer pipes.

As in the above-described embodiment, the combined heat exchanger 20 desirably has a structure in which the first heat medium and the refrigerant directly exchange heat, the first heat medium and the second heat medium directly exchange heat, and the refrigerant and the second heat medium indirectly exchange heat via the first heat medium, but is not limited thereto. The combined heat exchanger 20 may have a structure in which, for example, the first heat medium and the second heat medium directly exchange heat, the second heat medium and the refrigerant directly exchange heat, and the first heat medium and the refrigerant indirectly exchange heat via the second heat medium.

The refrigerant flow channel portion 21 of the combined heat exchanger 20 is configured as the evaporation portion that evaporates the refrigerant depressurized in the second depressurization valve 18, but is not limited thereto and may also be configured as a condensing portion that condenses the refrigerant discharged from the compressor 11. It is desirable for the combined heat exchanger 20 to be disposed such that the entire heat exchanging part in the refrigerant flow channel portion 21 is in thermal contact with the first heat medium flow channel portion 22, but this is not essential. The refrigerant flow channel portion 21 is desirably configured such that the refrigerant flows downward, but is not limited thereto. The refrigerant flow channel portion 21 may be configured such that the refrigerant flows downward at least in a part connected to a refrigerant outlet. The refrigerant flow channel portion 21 may be configured such that the refrigerant flows upward or sideways.

The combined heat exchanger 20 is desirably configured such that the refrigerant and the first heat medium flow in countercurrent flow, but is not limited thereto, and may be configured such that the refrigerant and the first heat medium flow in parallel or orthogonal flow. In addition, the combined heat exchanger 20 is desirably configured such that the first heat medium and the second heat medium flow in countercurrent flow, but is not limited thereto, and may be configured such that the first heat medium and the second heat medium flow in parallel or orthogonal flow.

As in the above-described embodiment, the heat exchange system 1 is desirably configured such that each of the flow rate of the refrigerant flowing through the refrigerant flow channel portion 21, the flow rate of the first heat medium flowing through the first heat medium flow channel portion 22, and the flow rate of the second heat medium flowing through the second heat medium flow channel portion 23 can be freely adjusted, but is not limited to this. The heat exchange system 1 may be configured such that at least one of the flow rate of the refrigerant flowing through the refrigerant flow channel portion 21, the flow rate of the first heat medium flowing through the first heat medium flow channel portion 22, and the flow rate of the second heat medium flowing through the second heat medium flow channel portion 23 cannot be freely adjusted.

As in the above-described embodiment, when the heat exchange system 1 is desirably configured to increase the flow rate of the first heat medium flowing through the first heat medium flow channel portion 22 when the heat exchange system 1 enters the operation mode in which heat is exchanged between the refrigerant and the second heat medium via the first heat medium, but this is not essential. The heat exchange system 1 is desirably configured to reduce the flow rate of the refrigerant flowing through the refrigerant flow channel portion 21 when the heat exchange system 1 enters the operation mode in which the heat of the first heat generating element 64 is transferred to the second heat medium, but this is not essential.

In the above-described embodiment, the combined heat exchanger 20 is exemplified as being applied to the heat exchange system 1 for a vehicle. However, the combined heat exchanger 20 is not limited to a system for a moving object, and can also be applied to, for example, a stationary system or a portable system.

In the embodiments described above, it is needless to say that the elements forming the embodiments are not necessarily essential except in a case where those elements are clearly indicated to be essential in particular, a case where those elements are considered to be obviously essential in principle, and the like.

In the embodiments described above, when referring to the number, the numerical value, the amount, the range, and the like of the components of the embodiment, the present disclosure is not limited to a specific number of components of the embodiments, except in a case of being particularly noted as being essential, a case of being limited to a specific number in principle, and the like.

In the embodiments described above, when referring to the shape, the positional relationship, and the like of the component and the like, the present disclosure is not limited to the shape, the positional relationship, and the like, except in a case of being particularly noted, a case of being limited to a specific shape, a specific positional relationship in principle, and the like.

The control unit and the method therefor of the present disclosure may be realized by a dedicated computer provided by including a processor and a memory that are programmed to execute one or more functions embodied by a computer program. The control unit and the method therefor of the present disclosure may be realized by a dedicated computer provided by including a processor with one or more dedicated hardware logic circuits. The control unit and the method therefor of the present disclosure may be realized by one or more dedicated computers, each including a combination of a processor and a memory that are programmed to execute one or more functions and a processor including one or more hardware logic circuits. The computer program may be stored in a computer-readable non-transitory tangible recording medium as an instruction to be executed by the computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A combined heat exchanger configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element, the combined heat exchanger comprising:
a refrigerant flow channel portion configured to allow the refrigerant to flow through the refrigerant flow channel portion;
a first heat medium flow channel portion configured to allow the first heat medium to flow through the first heat medium flow channel portion; and
a second heat medium flow channel portion configured to allow the second heat medium to flow through the second heat medium flow channel portion, wherein
the refrigerant flow channel portion, the first heat medium flow channel portion, and the second heat medium flow channel portion are arranged to transfer heat of the refrigerant to both the first heat medium and the second heat medium,
the first heat medium is a liquid-phase fluid that flows through the first heat medium circuit without phase change,
the first heat medium flow channel portion is disposed adjacent to the refrigerant flow channel portion to directly transfer the heat of the refrigerant to the first heat medium, and
the second heat medium flow channel portion is disposed adjacent to the first heat medium flow channel portion to indirectly transfer the heat of the refrigerant to the second heat medium via the first heat medium.

2. The combined heat exchanger according to claim 1, wherein
the first heat medium flow channel portion and the second heat medium flow channel portion are disposed adjacent to each other to transfer heat of the first heat generating element to the second heat medium via the first heat medium.

3. The combined heat exchanger according to claim 1, wherein
the refrigeration cycle includes a compressor configured to compress and discharge the refrigerant, a heat release device configured to release the heat of the refrigerant discharged from the compressor, and a depressurization portion that depressurizes the refrigerant that has passed through the heat release device, and
the refrigerant flow channel portion forms an evaporation portion configured to evaporate the refrigerant depressurized in the depressurization portion to transfer cold energy of the refrigerant to both the first heat medium and the second heat medium.

4. The combined heat exchanger according to claim 1, wherein
the first heat medium circuit is provided with a radiator configured to exchange heat between the first heat medium and outside air.

5. The combined heat exchanger according to claim 1, wherein
the second heat generating element includes a battery.

6. The combined heat exchanger according to claim 1, wherein
the second heat generating element includes heat generating bodies, and
the second heat medium circuit is configured to transfer heat of a heat generating body to another heat generating body among the heat generating bodies via the second heat medium.

7. The combined heat exchanger according to claim 1, wherein
the second heat medium is higher in electrical insulation property than the first heat medium.

8. The combined heat exchanger according to claim 1, wherein
the refrigerant flow channel portion is adjacent to the first heat medium flow channel portion to directly transfer the heat of the refrigerant to the first heat medium, and an entire heat exchanging part in the refrigerant flow channel portion is in thermal contact with the first heat medium flow channel portion.

9. The combined heat exchanger according to claim 1, wherein
the first heat medium flow channel portion includes a first heat exchanging unit that exchanges heat between the first heat medium and the refrigerant, and a second heat exchanging unit that exchanges heat between the first heat medium and the second heat medium, and is configured to allow the first heat medium to flow through the first heat exchanging unit and the second heat exchanging unit in this order.

10. The combined heat exchanger according to claim 1, wherein
the refrigerant includes refrigerator oil, and
the refrigerant flow channel portion is configured to allow the refrigerant to flow downward.

11. The combined heat exchanger according to claim 1, wherein
the refrigerant flow channel portion and the first heat medium flow channel portion are arranged to allow the refrigerant and the first heat medium to flow in countercurrent, and
the first heat medium flow channel portion and the second heat medium flow channel portion are arranged to allow the first heat medium and the second heat medium to flow in countercurrent.

12. A heat exchange system configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element, the heat exchange system comprising:
a combined heat exchanger that includes
a refrigerant flow channel portion configured to allow the refrigerant to flow through the refrigerant flow channel portion,
a first heat medium flow channel portion configured to allow the first heat medium to flow through the first heat medium flow channel portion, and
a second heat medium flow channel portion configured to allow the second heat medium to flow through the second heat medium flow channel portion; and
a flow rate adjustment unit configured to adjust a flow rate of the refrigerant flowing through the refrigerant flow channel portion, a flow rate of the first heat medium flowing through the first heat medium flow channel portion, and a flow rate of the second heat medium flowing through the second heat medium flow channel portion, wherein
the refrigerant flow channel portion, the first heat medium flow channel portion, and the second heat medium flow channel portion are arranged to transfer heat of the refrigerant to both the first heat medium and the second heat medium,
the first heat medium flow channel portion is disposed adjacent to the refrigerant flow channel portion to directly transfer the heat of the refrigerant to the first heat medium,
the second heat medium flow channel portion is disposed adjacent to the first heat medium flow channel portion to indirectly transfer the heat of the refrigerant to the second heat medium via the first heat medium, and
the flow rate adjustment unit is configured to increase the flow rate of the first heat medium flowing through the first heat medium flow channel portion in an operation mode in which heat is exchanged between the refrigerant and the second heat medium via the first heat medium.

13. A heat exchange system configured to exchange heat between a refrigerant circulating through a vapor compression type refrigeration cycle, a first heat medium flowing through a first heat medium circuit including a first heat generating element, and a second heat medium flowing through a second heat medium circuit including a second heat generating element, the heat exchange system comprising:
a combined heat exchanger that includes
a refrigerant flow channel portion configured to allow the refrigerant to flow through the refrigerant flow channel portion,
a first heat medium flow channel portion configured to allow the first heat medium to flow through the first heat medium flow channel portion, and
a second heat medium flow channel portion configured to allow the second heat medium to flow through the second heat medium flow channel portion; and
a flow rate adjustment unit configured to adjust a flow rate of the refrigerant flowing through the refrigerant flow channel portion, a flow rate of the first heat medium flowing through the first heat medium flow channel portion, and a flow rate of the second heat medium flowing through the second heat medium flow channel portion, wherein
the refrigerant flow channel portion, the first heat medium flow channel portion, and the second heat medium flow channel portion are arranged to transfer heat of the refrigerant to both the first heat medium and the second heat medium,
the first heat medium flow channel portion and the second heat medium flow channel portion are disposed adjacent to each other to transfer heat of the first heat generating element to the second heat medium via the first heat medium, and
the flow rate adjustment unit is configured to reduce the flow rate of the refrigerant flowing through the refrigerant flow channel portion in an operation mode in which the heat of the first heat generating element is transferred to the second heat medium.
